(19) United States
(12) Patent Application Publication
(10) Pub. No.: US 2010/0220299 A1
(43) Pub. Date: Sep. 2, 2010

(54) IMAGE DISPLAY DEVICE

(76) Inventors: Tetsuro Mizushima, Osaka (JP); Tatsuo Itoh, Osaka (JP); Toshifumi Yokoyama, Osaka (JP); Akira Kurozuka, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/301,896

(22) PCT Filed: May 18, 2007
(86) PCT No.: PCT/JP2007/060195

§ 371 Date: Nov. 21, 2008

(30) Foreign Application Priority Data
May 26, 2006 (JP) 2006-146398

(51) Int. Cl. G02B 27/48; G03B 21/14

(52) U.S. Cl. 353/38

(57) ABSTRACT

An image display device is provided with an image display unit for displaying an image visually recognizable by a viewer. The image display unit includes a sub-diffusion layer for diffusing laser light, a vibrator for vibrating the sub-diffusion layer, a primary diffusion layer for diffusing the laser light diffused by the sub-diffusion layer and a light shielding layer for cutting off outside light from a viewer side, wherein the primary diffusion layer and the light shielding layer are arranged at the viewer side of the sub-diffusion layer.

### FIELD OF THE INVENTION

The present invention relates to an image display device using a laser light source.

### DESCRIPTION OF THE BACKGROUND ART

Projection displays for projecting an image on a screen are widely used as image display devices. A lamp light source is generally used in such a projection display, but the lamp light source has problems of a short life, a restricted color reproduction area and low light utilization efficiency.

In order to solve these problems, an attempt has been made to use a laser light source as a light source of an image display device. The laser light source has a longer life and the light utilization efficiency thereof is more easily increased due to its strong directivity. Further, since the laser light source has monochromaticity, a color reproduction area is large and a vivid image can be displayed.

However, in a display using a laser light source (hereinafter, called a “laser display”), speckle noise produced due to high coherency of laser light becomes problematic. The speckle noise is noise of microscopic particles produced as a result of mutual interference of diffused lights when laser light is diffused on a screen and perceivable by an observer. The speckle noise is noise in which particles of the size determined by the F (F-number) of the observer's eyes and the wavelength of the laser light source are randomly arranged, disrupts the perception of an image on the screen by the observer and induces severe image deterioration.

A number of methods for reducing speckle noise have been proposed thus far and a method for generating speckle patterns differing with time by vibrating a screen has been proposed as a countermeasure using the screen (display unit). Screen vibration by a piezoelectric element is proposed in patent literature 1, and it is proposed in patent literature 2 that a display unit is constituted by two or more screens and at least one of them is vibrated by airflow. Further, it is proposed in patent literature 3 to change a diffusion layer with time and in patent literature 4 to internally vibrate a diffusion layer.

However, it is effective to vibrate the screen in order to reduce the speckle noise, but new problems occur which include noise produced by the screen vibration, image deterioration such as image blurring caused by the screen vibration, the detection of the screen vibration by a viewer to bring discomfort to the viewer.

As the screen is enlarged, it is required to enlarge a screen vibrating mechanism and it is becoming difficult to ensure the reliability of the vibrating mechanism.

### Patent Literature 1:

Japanese Unexamined Patent Publication No. S55-65940

### Patent Literature 2

Japanese Unexamined Patent Publication No. 2005-107150

### Patent Literature 3:

Japanese Unexamined Patent Publication No. 2001-100316

### Patent Literature 4:

Japanese Unexamined Patent Publication No. 2001-100317

### DISCLOSURE OF THE INVENTION

An object of the present invention is to provide an image display device capable of displaying a high-quality image, which is natural to a viewer, even under outside light illumination while removing speckle noise.

One aspect of the present invention is directed to an image display device, comprising an image display unit for displaying an image visually recognizable by a viewer, wherein the image display unit includes a sub-diffusion layer for diffusing laser light, a vibrator for vibrating the sub-diffusion layer, a primary diffusion layer for diffusing the laser light diffused by the sub-diffusion layer and a light shielding layer for cutting off outside light from a viewer side, and the primary diffusion layer and the light shielding layer are arranged at a viewer side of the sub-diffusion layer.

In the above image display device, since the primary diffusion layer and the light shielding layer are arranged at the viewer side of the sub-diffusion layer, to which vibration is applied by the vibrator, and outside light from the viewer side is cut off by the light shielding layer, it is possible to remove speckle noise resulting from the use of the laser light and to suppress image deterioration caused by outside light illumination without the vibration of the sub-diffusion layer being detected by the viewer. Therefore, an image, which is natural and vivid and has high contrast, can be displayed.

### BRIEF DESCRIPTION OF THE INVENTION

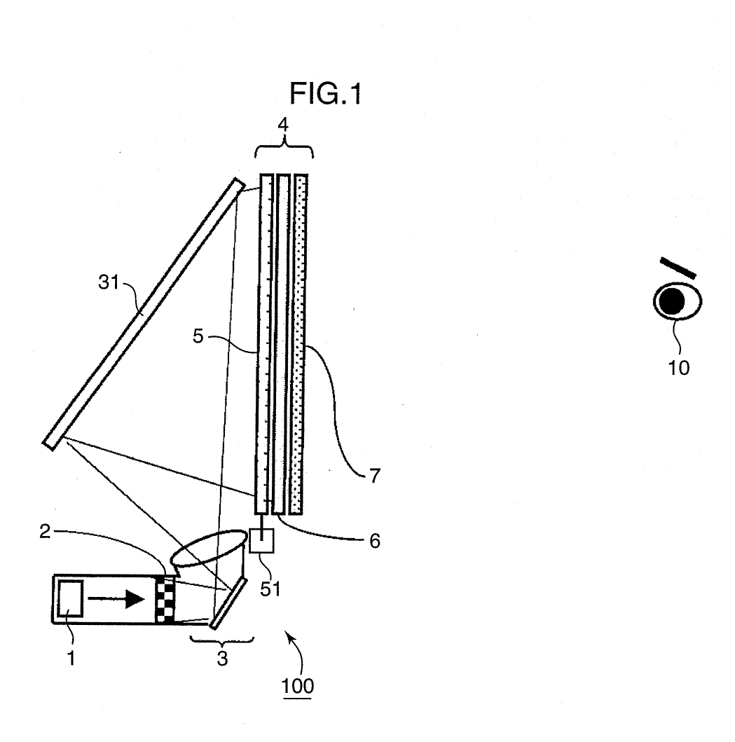

FIG. 1 is a diagram showing a schematic construction of an image display device according to a first embodiment of the invention,

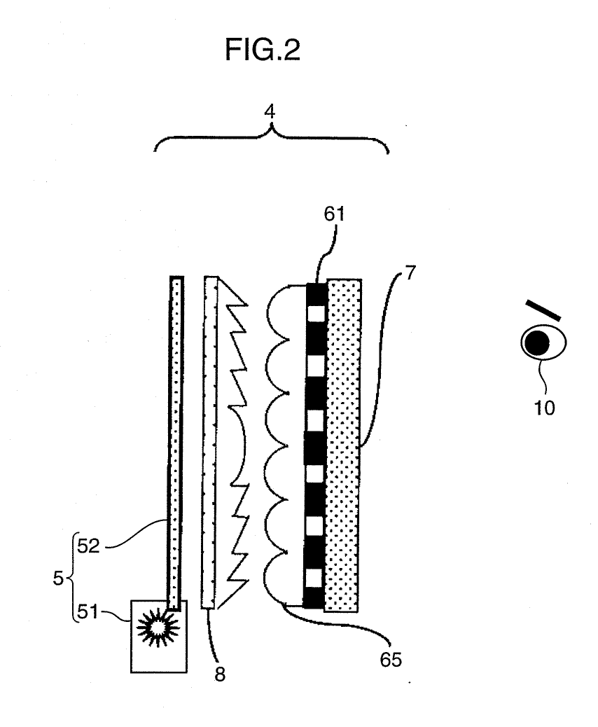

FIG. 2 is a schematic section showing the construction of an image display unit,

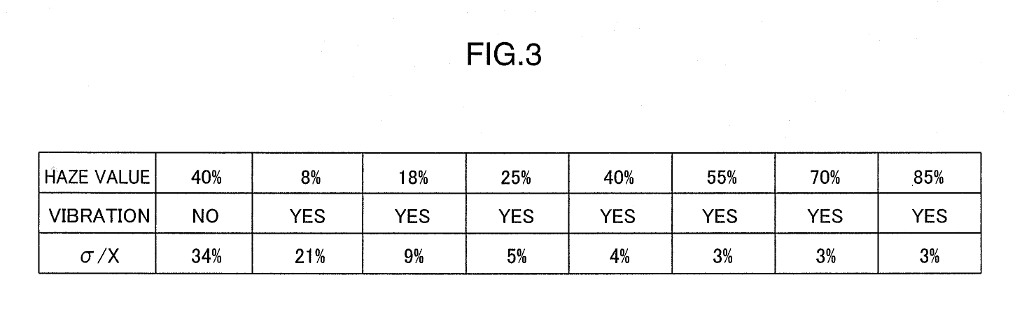

FIG. 3 is a table showing a relationship between a haze value Hs of a sub-diffusion layer and a speckle removing effect,

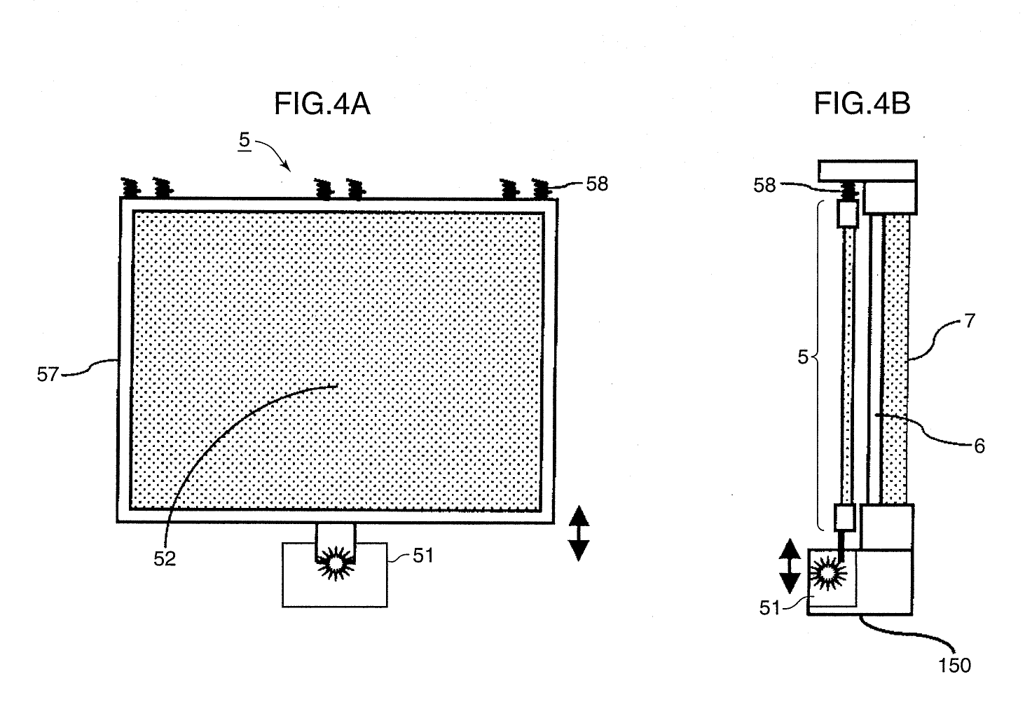

FIG. 4A is a schematic front view showing the constructions of the sub-diffusion layer and a vibrator and FIG. 4B is a schematic section showing the constructions of the sub-diffusion layer and the vibrator,

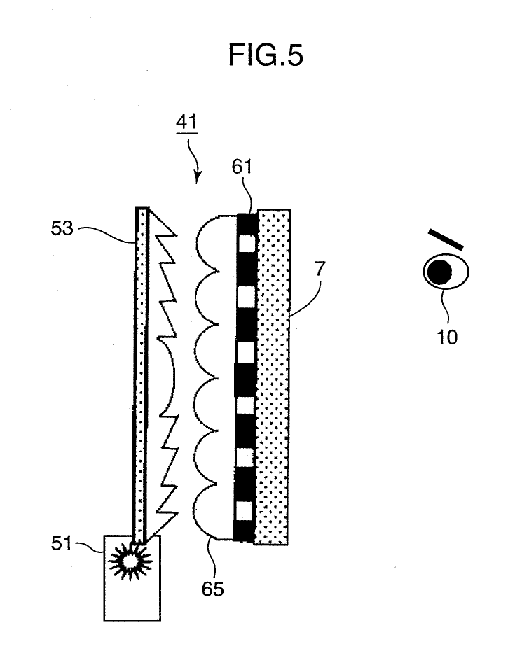

FIG. 5 is a schematic section showing the construction of an image display unit of an image display device according to a second embodiment of the invention,

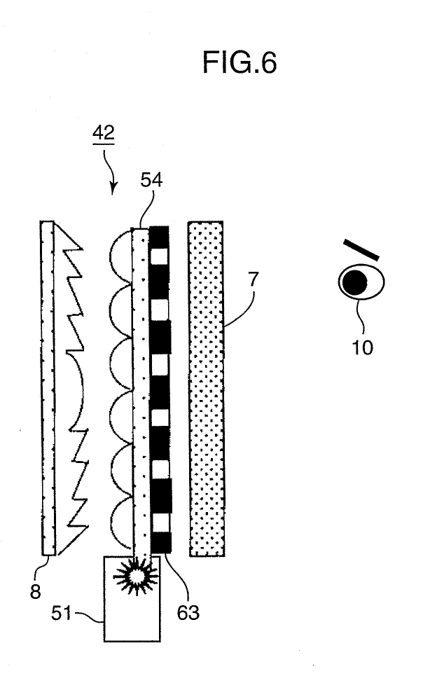

FIG. 6 is a schematic section showing the construction of an image display unit of an image display device according to a third embodiment of the invention,

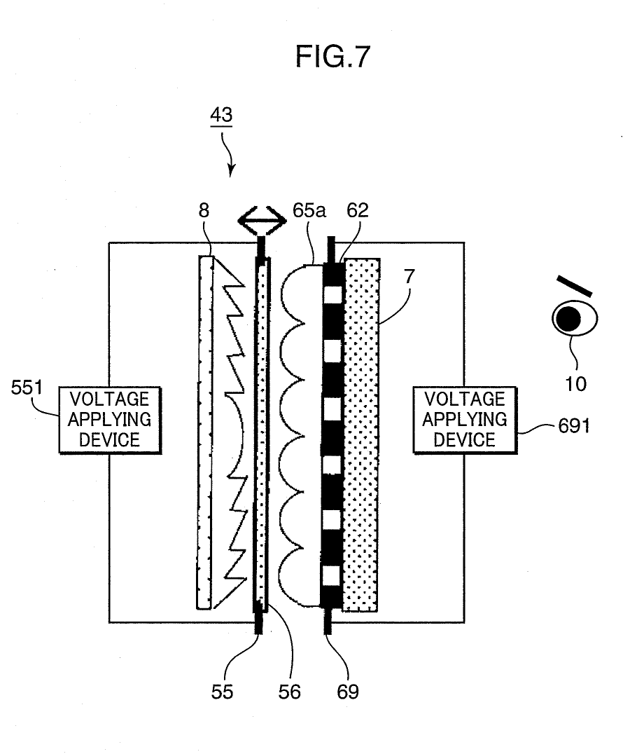

FIG. 7 is a schematic section showing the construction of an image display unit of an image display device according to a fourth embodiment of the invention,

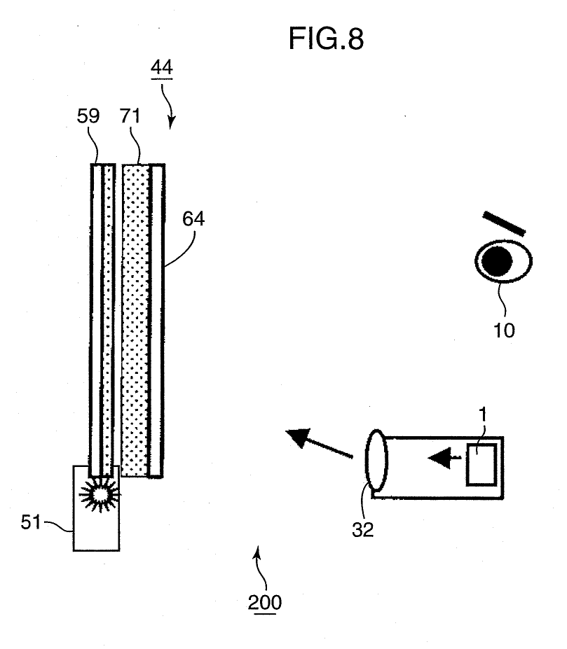

FIG. 8 is a schematic diagram showing a schematic construction of an image display device according to a fifth embodiment of the invention, and

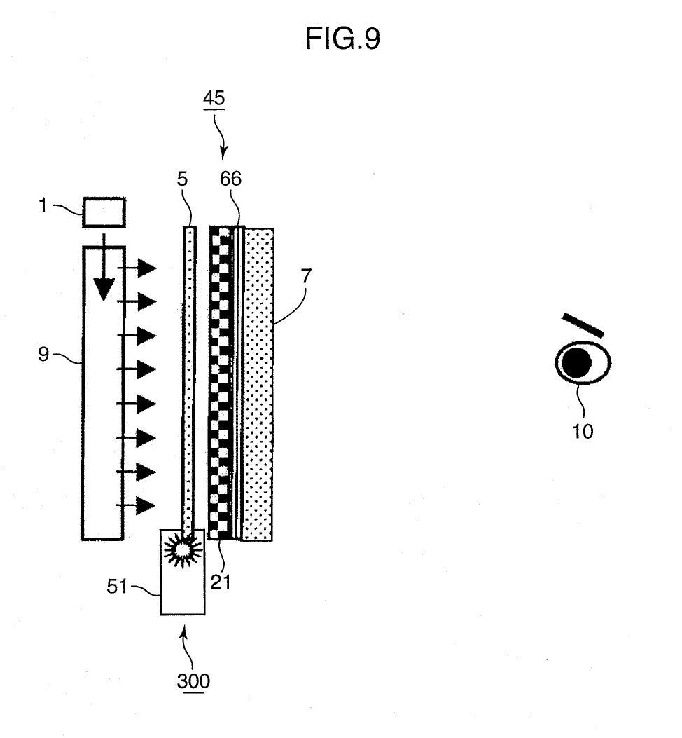

FIG. 9 is a diagram showing a schematic construction of an image display device according to a sixth embodiment of the invention.

### BEST MODES FOR EMBODYING THE INVENTION

Hereinafter, embodiments of the present invention are described with reference to the drawings. The same parts are identified by the same reference numerals and parts identified by the same reference numerals in the drawings may not be repeatedly described.

### First Embodiment

FIG. 1 is a diagram showing a schematic construction of an image display device 100 according to a first embodiment of the present invention. The image display device 100 according to this embodiment relates to a rear projection display (laser display), for example, using a laser light source.

In FIG. 1, the image display device 100 according to this embodiment is provided with a laser light source 1, a modulation element 2, a projection optical system 3, a rear mirror 31 and an image display unit 4. Light emitted from the laser light source 1 illuminates the modulation element 2 via an unillustrated illumination optical system. The light emitted from the laser light source 1 is modulated by the modulation element 2 and then enlargedly displayed on the image display unit 4 via the projection optical system 3 and the rear mirror 31. A viewer 10 observes an image displayed on the image display unit 4 from right side in FIG. 1.

The image display unit 4 includes a sub-diffusion layer 5, a light shielding layer 6 and a primary diffusion layer 7, wherein the light shielding layer 6 and the primary diffusion layer 7 are arranged at a side of the sub-diffusion layer 5 toward the viewer 10. In other words, an arrangement order of the sub-diffusion layer 5, the light shielding layer 6 and the primary diffusion layer 7 relative to the viewer 10 is set so that the presence of the sub-diffusion layer 5 is not directly visually recognized by the viewer 10.

The sub-diffusion layer 5 includes a vibrator 51 for controlling vibration applied to the sub-diffusion layer 5 so that a diffused state by the sub-diffusion layer 5 changes with time. Vibration is applied to the sub-diffusion layer 5 by the vibrator 51, whereby light having different phase and angle depending on time is emitted from the sub-diffusion layer 5. The light emitted from the sub-diffusion layer 5 is diffused by the primary diffusion layer 7, and the viewer 10 observes the image by the light diffused by the primary diffusion layer 7. In other words, the viewer 10 observes the diffused light whose phase and angle change with time by the presence of the sub-diffusion layer 5. Speckle noise occurs when the laser light is randomly diffused upon passing and being reflected by a diffusing material and diffused waves overlap at the retina of the viewer 10, and is noise in a glaring speckle pattern. In this embodiment, the speckle pattern is changed by changing the phase and angle of the diffused waves emitted from the image display unit 4 with time using the sub-diffusion layer 5. The viewer 10 perceives the changing speckle patterns in a cumulative manner with time, whereby the brightness of the speckles of the speckle noise is averaged and the viewer 10 comes to no longer perceive the speckle noise.

The light shielding layer 6 is arranged closer to the viewer 10 than the sub-diffusion layer 5 and prevents image deterioration caused when outside light such as illumination light arranged at the viewer 10 side is reflected and diffused by the image display unit 4 and observed by the viewer 10. Simultaneously, the light shielding layer 6 prevents the outside light from reaching the sub-diffusion layer 5. If the viewer 10 observes the outside light having reached the sub-diffusion layer 5 to change the diffused state, a change of the diffused state of the image display unit 4 with time is detected and the viewer 10 feels new discomfort. Thus, the incidence of the outside light from the viewer 10 side on the sub-diffusion layer 5 is prevented by providing the light shielding layer 6. In this way, the appearance of the outside light and contrast deterioration are suppressed and the viewer 10 can be prevented from detecting the change in the diffused state caused by the vibration of the sub-diffusion layer 5.

The primary diffusion layer 7 is arranged closer to the viewer 10 than the sub-diffusion layer 5 and diffuses image light which is changed with time by the sub-diffusion layer 5. By doing so, it can be made more difficult for the viewer 10 to detect the change of the image light with time. Since the reflection and diffusion of the outside light by the primary diffusion layer 7 do not change with time, it can be prevented that discomfort caused by the change in the diffused state by the sub-diffusion layer 5 is given to the viewer 10. Image display to the viewer 10 is made by the primary diffusion layer 7 arranged close to the viewer 10. Thus, even if the sub-diffusion layer 5 vibrates, image deterioration such as blurring does not occur and a high-quality image can be displayed to the viewer 10 by the diffusion by the primary diffusion layer 7.

The primary diffusion layer 7 and the light shielding layer 6 also have an effect of cutting driving sound produced by the vibration of the sub-diffusion layer 5. The light shielding layer 6 and the primary diffusion layer 7 arranged at the viewer 10 side of the sub-diffusion layer 5 prevent the above driving sound from being transmitted from the image display unit 4 to the viewer 10. Therefore, the driving sound produced by the vibration of the sub-diffusion layer 5 is not detected by the viewer 10 and the vibration of the sub-diffusion layer 5 does not hinder the image observation by the viewer 10.

The primary diffusion layer 7 and the light shielding layer 6 also have an effect of preventing a vibrating mechanism for the sub-diffusion layer 5 from external factors such as external pressure given from the viewer 10 side and the adhesion of liquid and the like. As the image display unit 4 is enlarged, it has become essential to make the sub-diffusion layer 5 lighter. Thus, the vibration of the sub-diffusion layer 5 by the vibrator 51 of the sub-diffusion layer 5 is likely to result in an incomplete operation in the case of an external pressure or liquid adhesion. This could be caused not only in the case where pressure directly acts on the vibrating sub-diffusion layer 5 or liquid, dust and dirt directly adhere to the vibrating sub-diffusion layer 5, but also in the case where the driving of the vibrator 51 is hindered due to the influence of pressure application and the adhesion of liquid or the like on the vibrator 51 itself. Accordingly, in this embodiment, by arranging the primary diffusion layer 7 and the light shielding layer 6 at the viewer 10 side of the sub-diffusion layer 5, the above external factors are suppressed by the primary diffusion layer 7 and the light shielding layer 6 to prevent the vibration of the sub-diffusion layer 5 from being hindered.

According to the image display device 100 of this embodiment, the speckle noise produced by the use of the laser light source can be removed without the change of the diffused state with time by the image display unit 4 being detected by the viewer 10. Thus, it is possible to display an image, which is free from image deterioration, natural and vivid and has high contrast, even under outside light illumination.

Next, the specific construction of the image display unit 4 is described. FIG. 2 is a schematic section showing the construction of the image display unit 4. As shown in FIG. 2, the image display unit 4 includes the sub-diffusion layer 5, a Fresnel lens 8, a lenticular lens 65, a light shielding layer 61, and a primary diffusion layer 7. The light shielding layer 61 is formed with a pattern in which transmitting portions are arranged at focusing portions of the lenticular lens 65 and light shielding portions made of a light absorbing material are arranged at positions other than the focusing portions. The lenticular lens 65, the light shielding layer 61 and the primary diffusion layer 7 are bonded to be united. In FIG. 2, a frame for fixing the image display unit 4 and the like are not shown for simplification. The size of the image display unit 4 is, for example, 52 inches diagonal.

The sub-diffusion layer 5 includes a diffusion film 52 and the vibrator 51. An uneven pattern was formed on the outer surface of the diffusion film 52, the thickness and haze value of the diffusion film 52 were 50 μm and 40% and the weight thereof including a simultaneously vibrating frame portion was about 150 g. The vibrator 51 includes a voice coil motor and changes the diffused state of the sub-diffusion layer 5 with time by vertically vibrating the diffusion film 52 in FIG. 2. A vertical stroke (amplitude) of the voice coil motor in FIG. 2 was 500 μm and the vibrational frequency thereof was 15 Hz. In reducing the speckle noise, the amplitude of the vibration by the voice coil motor is preferably about several-fold of the size of the diffusing material of the diffusion film 52. If the size of the diffusing material is about 50 μm, the amplitude is preferably about 100 to 200 μm. If the size of the diffusing material is about several μm, the amplitude is preferably about 10 μm. The vibrational frequency is preferably at least about several Hz.

The Fresnel lens 8 converts the projected image light from the rear mirror 31 into substantially parallel light and directs the light forward of the image display unit 4. The Fresnel lens 8 is united with a resin plate, in which a diffusing agent is mixed. The lenticular lens 65 is made up of a multitude of cylindrical lenses horizontally arranged side by side with respect to the projected light and increases a view angle in the horizontal direction by spreading the light in the horizontal direction.

The primary diffusion layer 7 includes a resin plate obtained by mixing a diffusing material into a base material, the diffusing material and the base material having different refractive indices. The thickness of the resin plate was 2 mm, the haze value thereof was 85% and the weight thereof was about 1.8 Kg. A hard coating for preventing scratches, fingerprints and the like by the viewer 10 is provided on the surface of the primary diffusion layer 7 toward the viewer 10. Besides, an AR processing and a diffusion processing for preventing the reflection and appearance of outside light may be applied to the surface. By such processings to the surface of the primary diffusion layer 7, external factors from the viewer 10 side are dealt with to protect the sub-diffusion layer 5. In this way, the sub-diffusion layer 5 can be made lighter without reducing the reliability thereof against the external factors.

The light shielding layer 61 has a stripe pattern in which the light shielding portions made of a black light absorbing material and the transmitting portions for transmitting the image light from the lenticular lens 65 are arranged. The outside light from the viewer 10 side is absorbed by the light shielding portions. A volume ratio of the light shielding portions in the light shielding layer 61 was 70%. The light shielding layer 61 transmits the image light through the transmitting portions while preventing deterioration in image contrast and the like in the image display unit 4 by absorbing light (outside light) different from the image light by means of the light shielding portions. By having the transmitting portions for the image light as a patterned structure in conformity with an incident angle condition of the image light on the image display unit 4, the light shielding layer 61 can absorb only the outside light. In the example shown in FIGS. 1 and 2, the pattern of the light shielding portions and the transmitting portions of the light shielding layer 61 are determined by the incident angle condition of the image light determined by the projection optical system 3, the sub-diffusion layer 5, the Fresnel lens 8 and lenticular lens 65. The volume ratio of the light shielding portions in the light shielding layer 61 is preferably 50% or higher, more preferably 60% or higher. By increasing the volume ratio of the light shielding portions, an outside light absorbing effect can be further improved. Further, the volume ratio of the light shielding portions is preferably 90% or lower. If the volume ratio exceeds 90%, the light diffused by the sub-diffusion layer 5 is absorbed by the light shielding portions, whereby the image light is lost and the reduction of the speckle noise is hindered.

In the image display unit 4, the primary diffusion layer 7, the light shielding layer 61 and the sub-diffusion layer 5 are preferably arranged in this order from the viewer 10 side. Since the image light having passed the primary diffusion layer 7 has a large diffusion angle, if the light shielding layer 61 is provided at the side of the primary diffusion layer 7 toward the viewer 10, the image light is cut off together with the outside light, thereby being lost. By employing the above arrangement, the loss of the image light can be prevented. As shown in FIG. 2, the Fresnel lens 8 and the lenticular lens 65 may be inserted between the above layers.

The haze value Hm of the primary diffusion layer 7 and the haze value Hs of the sub-diffusion layer 5 are preferably in the following relationship.

10%<Hs<Hm

A haze value indicates a degree of diffusion and is a value obtained by dividing a diffuse transmittance by a total beam transmittance. In this relationship, the diffusing effect of the primary diffusion layer 7 is larger than that of the sub-diffusion layer 5. If the diffusing effect of the primary diffusion layer 7 is smaller than that of the sub-diffusion layer 5, the change of the diffused state of the image light with time caused by the sub-diffusion layer 5 is more easily detected by the viewer 10. Thus, the detection of the change of the image with time by the viewer 10 can be prevented by satisfying the above relationship. Particularly, in the case of using the light shielding layer 61 having the light shielding portions and transmitting portions as shown in FIG. 2, the loss of the image light by the light shielding layer 61 increases if the diffusing effect of the sub-diffusion layer 5 is designed to be larger than that of the primary diffusion layer 7. Thus, the diffusing effect of the primary diffusion layer 7 is preferably larger than that of the sub-diffusion layer 5. Further, if the haze value of the sub-diffusion layer 5 is 10% or lower, it is difficult to obtain a sufficient diffusing effect to reduce the speckle noise even if the sub-diffusion layer 5 is vibrated. More preferably, the haze value Hs of the sub-diffusion layer 5 is 20% or higher. If the haze value Hs is 20% or higher, the speckle noise can be reduced to such a level substantially undetectable by the viewer 10.

By setting the diffusing effect of the sub-diffusion layer 5 smaller than that of the primary diffusion layer 7, the disturbance of the image light caused by the vibration of the sub-diffusion layer 5 is suppressed and the diffusion of the primary diffusion layer 7 as a principal display surface becomes a main cause of image generation. The primary diffusion layer 7 functions as the principal display surface of the image display unit 4, whereby a high-quality image can be displayed.

FIG. 3 shows an evaluation result showing a relationship between the haze value Hs of the sub-diffusion layer 5 and a speckle removing effect. In FIG. 3, 8%, 18%, 25%, 40%, 55%, 70% and 85% are selected as the haze value Hs of the sub-diffusion layer 5, and the haze value Hm of the primary diffusion layer 7 is 85%. This evaluation is a result obtained by measuring a fluctuation σ (standard deviation)/X (average luminance) of image luminance caused by the speckle noise using a virtual visual camera. From the result on the presence or absence of the vibration of the sub-diffusion layer 5 when the haze value Hs of the sub-diffusion layer 5 is 40%, it can be understood that the luminance fluctuation (σ/X) caused by the speckle noise decreases by applying vibration to the sub-diffusion layer 5 using the vibrator 51.

On the other hand, if the haze value Hs of the sub-diffusion layer 5 was below 10%, σ/X was 20% or higher and the luminance fluctuation was perceived by the eyes of the viewer 10. σ/X decreases and the speckle noise is suppressed by increasing the haze value Hs of the sub-diffusion layer 5 to or above 10%. Particularly, by increasing the haze value Hs of the sub-diffusion layer 5 to or above 20%, σ/X decreases to or below 5% and the speckle noise can be removed to a level unnoticeable by the viewer 10. When the haze value Hs of the sub-diffusion layer 5 was set to the same value of 85% as that of the primary diffusion layer 7, image light disturbance was seen, image deterioration occurred and the fluctuation of the image caused by the vibration of the sub-diffusion layer 5 was detected. Further, a light quantity loss of 30% or more occurred.

The weight of the sub-diffusion layer 5 is preferably smaller than that of the primary diffusion layer 7. The weight of the sub-diffusion layer 5 is the weight of an actually vibrating part. In FIG. 2, it is the weight of the diffusion film 52, the frame portion for the diffusion film 52 simultaneously vibrating with the diffusion film 52 and a part of the vibrator 51. The weight of the primary diffusion layer 7 is the weight of the diffusing plate constituting the primary diffusion layer 7. In FIG. 2, it is the sum of the weight of the primary diffusion layer 7 and the weight of an adhesive layer to the light shielding layer 61 and the hard coating on the outer surface of the primary diffusion layer 7. By setting the weight of the sub-diffusion layer 5 vibrating in the image display unit 4 smaller than that of the primary diffusion layer 7, the transmission of the vibration of the sub-diffusion layer 5 to the outside of the image display unit 4 is suppressed. More preferably, the weight of the sub-diffusion layer 5 is equal to or below ⅕ of the weight of the primary diffusion layer 7. By setting so, the transmission of the vibration of the sub-diffusion layer 5 to the outside can be further prevented. By setting the primary diffusion layer 7 heavier than the sub-diffusion layer 5 that vibrates, the primary diffusion layer 7 has an effect of preventing the transmission of driving sound produced by the vibration of the sub-diffusion layer 5 to the outside.

The thickness of the sub-diffusion layer 5 is preferably below 500 μm. In FIG. 2, the thickness of the diffusion film 52 as the sub-diffusion layer 5 is 50 μm. By thinning the sub-diffusion layer 5, the sub-diffusion layer 5 can be made lighter, the vibrator 51 can be simplified, and vibration in an optical axis direction (lateral direction of FIG. 2) is possible. Since the sub-diffusion layer 5 can be made lighter by setting the thickness of the sub-diffusion layer 5 below 500 μm, the vibrator 51 can be miniaturized and can be reliable over a long term even if the image display unit 4 is enlarged into a large screen. In this embodiment, by setting the thickness of the diffusion film 52 to 50 μm to make the sub-diffusion layer 5 lighter, the vibrator 51 can be realized by one small-size voice coil motor for a large screen of 50 inches or more.

The vibrational frequency of the vibrator 51 of the sub-diffusion layer 5 is preferably below 20 Hz. It is set to a frequency lower than the human audible range lest noise produced by the vibrator 51 should be detected by the viewer 10. By operating the vibrator 51 at a low frequency, the vibrator 51 can obtain long-term reliability. Since the sub-diffusion layer 5 entirely and integrally vibrates, it becomes a speaker of a driving frequency at the time of driving the sub-diffusion layer 5. Particularly, the large sub-diffusion layer 5 for large screen display has a problem of producing large sound. When the driving source was, accordingly, examined at a position 20 cm away from the image display unit 4, vibration noise was heard at a driving frequency of 100 Hz or higher even if the amplitude of the sub-diffusion layer 5 was about 10 μm. On the other hand, at a driving frequency of below 20 Hz, the driving sound was not heart at the same position even if the amplitude of the sub-diffusion layer 5 was 100 μm or larger and the image displayed by the image display unit 4 could be viewed without any problem.

The diffusion film 52 of FIG. 2 is vibrated in the vertical direction of FIG. 2 by the vibrator 51 to change the diffused state of the sub-diffusion layer 5 with time. The sub-diffusion layer 5 may be vibrated in the lateral direction of FIG. 2. Further, the vibration amplitude of the sub-diffusion layer 5 may be about several-fold of the size of the diffusing material of the diffusion film 52 and may be below 100 μm depending on the configuration of the diffusing material. It is sufficient for the vibrator 51 of the sub-diffusion layer 5 to be able to change the diffused state of the sub-diffusion layer 5 with time, and the diffusing material itself in the sub-diffusion layer 5 may be vibrated.

Although the Fresnel lens 8 and the lenticular lens 65 are inserted in addition to the sub-diffusion layer 5, the light shielding layer 61 and the primary diffusion layer 7 in FIG. 2, another layer for controlling the orientation characteristic of the image light and a coating or layer for preventing the influence of the outside light may be further provided.

Besides the base material mixed with the diffusing material, the primary diffusion layer 7 may be any layer exhibiting a diffusing effect such as a diffusion layer formed with an uneven outer surface provided that the image can be observed by the viewer 10 due to the diffused light by the primary diffusion layer 7.

Next, the specific constructions of the sub-diffusion layer 5 and the vibrator 51 are described. FIG. 4A is a schematic front view showing the constructions of the sub-diffusion layer 5 and the vibrator 51 and FIG. 4B is a schematic section showing the constructions of the sub-diffusion layer 5 and the vibrator 51.

As shown in FIGS. 4A and 4B, the diffusion film 52 made of transparent resin and formed with an uneven pattern is fixed by a frame portion 57 and the frame portion 57 is bonded to a vibrating part of the vibrator 51. The frame portion 57 is mounted in a housing 150 of the image display device 100 by mounting springs 58. Further, a fixing portion of the vibrator 51 is mounted in the housing 150 of the image display device 100. The vibrating part of the vibrator 51 is controlled to operate in the vertical direction of FIGS. 4A and 4B by a sine wave of 15 Hz, and the spring constant and number of the mounting springs 58 are set such that the sub-diffusion layer 5 resonates in the neighborhood of 15 Hz. The diffusion film 52 and the frame portion 57 are caused to make resonant motions by the vibrator 51 and the mounting springs 58.

According to the sub-diffusion layer 5 and the vibrator 51 shown in FIGS. 4A and 4B, the sub-diffusion layer 5 can be made lighter and reliable. By using the diffusion film 52 as the sub-diffusion layer 5, the sub-diffusion layer 5 can be made lighter even in the case of enlarging the image display unit 4. Further, by using the diffusion film 52, the durability of the diffusion film 52 reduced by vibration stress and unevenness caused by the crease of the diffusion film 52 become problematic. However, by fixing the resin film to the frame portion 57 and simultaneously vibrating it, these problems can be solved. Further, by causing the sub-diffusion layer 5 to make a resonant motion, the vibrator 51 can be controlled at lower power and the power consumption of the image display device 100 can be reduced.

### Second Embodiment

Next, a second embodiment of the present invention is described. This embodiment relates to an image display device provided with an image display unit having a construction different from the image display unit of the first embodiment. FIG. 5 is a schematic section showing the construction of the image display unit used in the image display device according to this embodiment.

As shown in FIG. 5, an image display unit 41 in this embodiment includes a sub-diffusion layer 53 provided with a vibrator 51, a lenticular lens 65, a light shielding layer 61 and a primary diffusion layer 7. Similar to the above first embodiment, the light shielding layer 61 is formed with a pattern in which transmitting portions are arranged at focusing portions of the lenticular lens 65 and light shielding portions are arranged at positions other than the focusing portions. The lenticular lens 65, the light shielding layer 61 and the primary diffusion layer 7 are united. The lenticular lens 65, the light shielding layer 61 and the primary diffusion layer 7 have the same construction as in the above first embodiment.

The sub-diffusion layer 53 has a lens surface formed with a Fresnel lens as one surface facing toward a viewer 10 and a diffusion surface having an uneven pattern as the other surface. The thickness and haze value of the diffusion film 53 were 200 μm and 60% and the weight thereof including a simultaneously vibrating frame portion was about 300 g. The sub-diffusion layer 53 vibrates at a stroke of 200 μm in a vertical direction of FIG. 5 at a frequency of 15 Hz. The sub-diffusion layer 53 converts projected image light into substantially parallel light by the Fresnel lens surface to orient the light forward of the image display unit 41, and changes a diffused state with time by having the diffusion surface and the vibrator 51.

This embodiment is a preferable embodiment in which the sub-diffusion layer 53 also has a Fresnel lens effect. By integrating the sub-diffusion layer 53 and the layer having a lens effect, the number of interfaces between air, in which the image light transmits, and constituent elements of the image display unit 41 can be reduced and the loss of the image light by surface reflection can be reduced while an orientation characteristic similar to that of the first embodiment is maintained.

Similar to the diffusion film 52 of the first embodiment, the sub-diffusion layer 53 is made of a resin film and is preferably fixed by the frame portion and vibrated together with the frame portion. Particularly, in the case of being integrated with the Fresnel lens, an orientation angle by the lens changes, for example, if the Fresnel lens surface is warped by the vibrator 51, whereby luminance nonuniformity occurs. Thus, it is preferable to fix the diffusion film by the frame portion and vibrate it together with the frame portion lest the Fresnel lens surface should be warped.

### Third Embodiment

Next, a third embodiment of the present invention is described. This embodiment relates to an image display device provided with an image display unit having a construction different from the image display units of the first and second embodiments. FIG. 6 is a schematic section showing the construction of the image display unit used in the image display device according to this embodiment.

As shown in FIG. 6, an image display unit 42 in this embodiment includes a Fresnel lens 8, a sub-diffusion layer 54 provided with a vibrator 51, a light shielding layer 63 and a primary diffusion layer 7.

A lenticular lens is formed on one surface of the sub-diffusion layer 54 and the light shielding layer 63 is bonded to the other surface thereof toward a viewer 10. In other words, the sub-diffusion layer 54 and the light shielding layer 63 are united and vibrated together by the vibrator 51. The primary diffusion layer 7 is the same as in the first embodiment, but different from the one in the second embodiment. The primary diffusion layer 7 is separated from the light shielding layer 63 without being bonded, and fixed to an image display device housing so as not to vibrate. The Fresnel lens 8 is the same as the one used in the first embodiment.

The sub-diffusion layer 54 and the light shielding layer 63 were united, and the thickness of the united assembly was 100 μm and the weight including a simultaneously vibrating frame portion was about 200 g. The sub-diffusion layer 54 and the light shielding layer 63 are vibrated with a vertical stroke of 200 μm in FIG. 6 at a frequency of 15 Hz by the vibrator 51. The haze value of the sub-diffusion layer 54 having the lenticular lens on the one surface was 30%. It should be noted that the haze value of the sub-diffusion layer 54 is a value including a diffusing effect of the lenticular lens.

Since the transmitting portions of the light shielding layer 63 vibrate together with the sub-diffusion layer 54, an incident light path on the primary diffusion layer 7 largely changes to diversify the speckle pattern, whereby speckle noise is reduced. This embodiment is a preferable embodiment in which the light shielding layer 63 and the sub-diffusion layer 54 vibrate to further reduce the speckle noise.

This embodiment is more preferable since the sub-diffusion layer 54 has the lenticular lens on the one surface and the transmitting portions can constantly transmit the image light even if the sub-diffusion layer 54 is vibrated together with the light shielding layer 63. Since the sub-diffusion layer 54 has the lenticular lens on the one surface, the loss of the image light caused by the vibration of the light shielding layer 63 can be reduced.

### Fourth Embodiment

Next, a fourth embodiment of the present invention is described. This embodiment relates to an image display device provided with an image display unit having a construction different from the image display units of the first to third embodiments. Specifically, the sub-diffusion layer is vibrated by an electromagnetic mechanism in this embodiment although it is done by the mechanical mechanisms in the first to third embodiments. FIG. 7 is a schematic section showing the construction of the image display unit used in the image display device according to this embodiment.

As shown in FIG. 7, an image display unit 43 in this embodiment includes a Fresnel lens 8, an electroconductive sub-diffusion layer 56, a lenticular lens 65a, an electroconductive light shielding layer 62 and a primary diffusion layer 7. The electroconductive sub-diffusion layer 56 and the electroconductive light shielding layer 62 are both electrically conductive, and an electrostatic force is produced between them by applying voltages to electrodes 55 of the electroconductive sub-diffusion layer 56 and electrodes 69 of the electroconductive light shielding layer 62. The electrodes 55 of the electroconductive sub-diffusion layer 56 are connected to a voltage applying device 551 and the electrodes 69 of the electroconductive light shielding layer 62 are connected to a voltage applying device 691. The lenticular lens 65a, the electroconductive light shielding layer 62 and the primary diffusion layer 7 are bonded and united, and fixed to an image display device housing. The primary diffusion layer 7 and the Fresnel lens 8 are the same ones as those used in the above first embodiment.

The electroconductive sub-diffusion layer 56 is vibrated by controlling the voltage in a lateral direction of FIG. 7 by an electrostatic force produced upon voltage application, utilizing its electrically conductive property. The thickness of the electroconductive sub-diffusion layer 56 was 50 μm and the weight thereof was about 50 g. The electroconductive sub-diffusion layer 56 is formed with transparent electrodes randomly arranged in a net-like manner on the outer surface of a resin film, and diffuses light by the uneven pattern of the transparent electrodes. This embodiment is a preferable embodiment in which the electrode material provides the film with an electrically conductive property while serving as a diffusing material. The haze value of the electroconductive sub-diffusion layer 56 was 40%. The electroconductive sub-diffusion layer 56 is not particularly limited provided that it has both electrically conductive property and diffusion property, and may be such that one surface of a normal diffusion film is coated with a transparent electrode film. This embodiment is preferable since the sub-diffusion layer 56 can be vibrated without using a mechanical motor by containing the electrically conductive material to be electrically conductive.

The electroconductive light shielding layer 62 has light shielding portions made of black carbon as an electrically conductive material so as to exhibit the electrically conductive property, and the electrodes 69 are formed such that the light shielding portions are electrically connected on the outer circumference of the image display unit 43. The electroconductive light shielding layer 62 and the electroconductive sub-diffusion layer 56 are partitioned by the lenticular lens 65a. In other words, the lenticular lens 65a also has an effect of a gap layer between the electroconductive light shielding layer 62 and the electroconductive sub-diffusion layer 56. By controlling the voltages in the electroconductive light shielding layer 62 and the electroconductive sub-diffusion layer 56, an electrostatic force is produced between these layers to vibrate the electroconductive sub-diffusion layer 56 in the lateral direction of FIG. 7. This embodiment is a preferable embodiment in which the electroconductive sub-diffusion layer 56 is vibrated, utilizing the electrostatic force between the electroconductive sub-diffusion layer 56 and the electroconductive light shielding layer 62, by containing the electrically conductive material in the electroconductive light shielding layer 62 and providing the gap layer between the electroconductive light shielding layer 62 and the electroconductive sub-diffusion layer 56. The electroconductive light shielding layer 62 is sufficient to have a function of cutting off outside light while containing the electrical conductive material, and is not limited to the above construction.

As described above, since the lenticular lens 65a doubles as the gap layer between the electroconductive light shielding layer 62 and the electroconductive sub-diffusion layer 56, it is preferably made of a resin lens plate as an insulator. When the electroconductive sub-diffusion layer 56 is controlled by the electrostatic force, it is preferable to provide the insulating gap layer between the electroconductive layers 56 and 62 so that the two electroconductive layers 56 and 62 do not attract each other. By causing the lenticular lens 65a for controlling the orientation of the image light to double as the gap layer, the structure can be simplified even if a vibrating mechanism is added.

In this embodiment, a mechanism is provided which detects any deterioration or disconnection of electrically conductive portions based on an electrically conductive state of the electroconductive sub-diffusion layer 56 or the electroconductive light shielding layer 62. For example, the voltage applying devices 551 and 691 for applying voltages to the electroconductive sub-diffusion layer 56 and the electroconductive light shielding layer 62 detect abnormality in the electrically conductive state at the time of voltage application. By doing so, some of the electrically conductive portions distributed on the entire surface of a screen, which are disconnected when the screen is broken, cracked or bored, can be quickly detected. In the case of detecting the breakage of the screen, the output of a laser light source of the image display device is stopped to prevent the image light from directly reaching the eyes of a viewer 10 without via the image display unit. The safety of the viewer 10 can be ensured by using the electrically conductive material for the sub-diffusion layer or the light shielding layer and providing the function of detecting the electrically conductive state. In order to detect the breakage of the screen, both the sub-diffusion layer and the light shielding layer may be used or only one of them may be used.

### Fifth Embodiment

Next, a fifth embodiment of the present invention is described. Although the image display devices according to the above first to fourth embodiments relate to the rear projection displays, an image display device according to this embodiment relates to a front projection display. FIG. 8 shows a schematic construction of an image display device 200 according to this embodiment.

In FIG. 8, the image display device 200 according to this embodiment is provided with a laser light source 1, a projection optical system 32, and an image display unit 44. The image display device 200 is a laser front projection display for projecting image light from a viewer 10 side to the image display unit 44. Light emitted from the laser light source 1 is modulated by an unillustrated modulation element and the modulated light is displayed on the image display unit 44 via the projection optical system 32.

The image display unit 44 includes a selected wavelength absorbing light shielding layer 64, a primary diffusion layer 71 and a reflective sub-diffusion layer 59 provided with a vibrator 51. One surface of the reflective sub-diffusion layer 59 is a reflection surface, and light emitted from the projection optical system 32 is reflected toward the viewer 10 by this reflection surface. The selected wavelength absorbing light shielding layer 64 and the primary diffusion layer 71 are bonded and united.

The selected wavelength absorbing light shielding layer 64 is a layer for transmitting light in a wavelength range of laser light as image light while selectively absorbing lights outside this wavelength range. By the selected wavelength absorbing light shielding layer 64, outside light at a viewer 10 side is absorbed before being diffused by the image display unit 44, thereby preventing image deterioration induced by the outside light. Further, the outside light do not reach the reflective sub-diffusion layer 59 and it is prevented that the vibration of the reflective sub-diffusion layer 59 is detected by the viewer 10. Since the image light is generated from the laser light having a very narrow spectral width in this embodiment, the wavelength range at variance with the image light is wide. Most components of the outside light are different from the spectrum of the image light, most of the outside light can be absorbed by selective absorption. The selected wavelength absorbing light shielding layer 64 is a preferable light shielding layer which becomes first effective by using the laser light source and can remove the outside light even in the front projection type display.

The primary diffusion layer 7 is made of a resin plate obtained by mixing a diffusing material into a base material, the diffusing material and the base material having different refractive indices. The thickness of the primary diffusion layer 7 was 1 mm, the haze value thereof was 70% and the weight thereof was about 900 g.

The reflective sub-diffusion layer 59 is such that an aluminum reflection film is formed on a surface thereof opposite to the viewer 10 by deposition and a diffusion surface with an uneven pattern is formed on the surface toward the viewer 10. The thickness of the reflective sub-diffusion layer 59 was 50 μm and the haze value thereof measured before the deposition of the reflection film was 40%. The weight including a simultaneously vibrating frame portion was about 150 g. The vibrator 51 vibrates the reflective sub-diffusion layer 59 at a vertical stroke of 500 μm in FIG. 8 at a vibrational frequency of 15 Hz.

The sub-diffusion layer and the reflection layer may be separated, and the reflection layer may be made of a dielectric multilayer film or a white diffusing material for selectively reflecting only the image light besides being made of aluminum.

### Sixth Embodiment

Next, a sixth embodiment of the present invention is described. Although the image display devices according to the above first to fourth embodiments relate to the rear projection displays and the image display device according to the fifth embodiment relates to the front projection display, an image display device according to this embodiment relates to a liquid crystal display. FIG. 9 shows a schematic construction of an image display device 300 according to this embodiment.

In FIG. 9, the image display device 300 according to this embodiment is provided with a laser light source 1, a light guiding plate 9 and an image display unit 45. Light emitted from the laser light source 1 is planarly uniformized by the light guiding plate 9 and emitted to the image display unit 45. The image display unit 45 includes a primary diffusion layer 7, a polarizing light shielding layer 66, a two-dimensional spatial modulation element 21 and a sub-diffusion layer 5 provided with a vibrator 51. The primary diffusion layer 7, the polarizing light shielding layer 66 and the two-dimensional space modulation element 21 are bonded and united. The primary diffusion layer 7 and the sub-diffusion layer 5 are the same ones as those used in the above first embodiment. The two-dimensional spatial modulation element 21 modulates laser light into an image using an image signal.

The polarizing light shielding layer 66 is a light shielding layer which transmits only light in a specified polarization direction while absorbing orthogonal polarized light components. The polarizing light shielding layer 66 can prevent image deterioration by the outside light and improve the contrast of modulated image light by absorbing the outside light having the polarized light components. Further, the outside light do not reach the sub-diffusion layer 5 and it is prevented that the vibration of the sub-diffusion layer 5 is detected by a viewer 10. In order to improve the contrast of the modulated image light, it is necessary to align the polarization direction of the polarizing light shielding layer 66 and that of unnecessary components of the image light. At this time, if the vibrating sub-diffusion layer 5 is present between the two-dimensional spatial modulation element 21 for modulating the image light and the polarizing light shielding layer 66, the polarization directions are disturbed and it is difficult to improve the image contrast. This embodiment is a preferable embodiment capable of improving the image contrast by providing the two-dimensional spatial modulation element 21 at an emergent side of the vibrating sub-diffusion layer 5 and providing the polarizing light shielding layer 66 at the side toward the viewer 10.

Similar the sub-diffusion layer 5, the primary diffusion layer 7 is preferably provided at the side of the polarizing light shielding layer 66 toward the viewer 10 as in this embodiment instead of being provided between the two-dimensional spatial modulation element 21 and the polarizing light shielding layer 66.

This embodiment can be used when the viewer 10 observes an image on the two-dimensional spatial modulation element in this way without using a projection optical system.

As described above, it is possible to remove the speckle noise and to constantly display a high-quality image according to the image display devices of the first to sixth embodiments of the present invention.

In the above first to sixth embodiments, the vibrating sub-diffusion layer can reduce the speckle noise if it is vibrated while being formed on the entire surface of the image display unit on which the viewer directly observes an image displayed.

In the above first to sixth embodiments, it is sufficient to construct the image display unit such that a displayed image can be observed by the viewer, and the image display unit may have a curved surface instead of the plane surface and the shape thereof is not limited to rectangular shapes.

In the above first to sixth embodiments, the modulation of the laser light of the laser light source is not limited to the one by the modulation element and the output of the laser light source may be modulated.

In the above first to sixth embodiments, the optical system of the image display device from the laser light source to the image display unit is not particularly limited to the above constructions.

The present invention can be summarized as follows from the above respective embodiments. Specifically, an image display device according to the present invention is the one comprising an image display unit for displaying an image visually recognizable by a viewer, wherein the image display unit includes a sub-diffusion layer for diffusing laser light, a vibrator for vibrating the sub-diffusion layer, a primary diffusion layer for diffusing the laser light diffused by the sub-diffusion layer and a light shielding layer for cutting off outside light from a viewer side, and the primary diffusion layer and the light shielding layer are arranged at a side of the sub-diffusion layer toward the viewer.

In the above image display device, since the primary diffusion layer and the light shielding layer are arranged at the viewer side of the sub-diffusion layer, to which vibration is applied by the vibrator, to cut off outside light from the viewer side by the light shielding layer, it is possible to remove speckle noise resulting from the use of laser light and to suppress image deterioration caused by outside light illumination without the vibration of the sub-diffusion layer being detected by the viewer. Therefore, an image, which is natural and vivid and has high contrast, can be displayed.

The primary diffusion layer is preferably arranged at the viewer side of the light shielding layer.

In this case, the quantity of light reaching the eyes of the viewer can be increased since the light diffused by the primary diffusion layer directly reach the viewer side.

The haze value Hm of the primary diffusion layer and the haze value Hs of the sub-diffusion layer preferably satisfy a relationship of 10%<Hs<Hm.

In this case, since a diffusing effect of the primary diffusion layer is larger than that of the sub-diffusion layer, the primary diffusion layer becomes a principal display surface and a change of the light caused by the vibration of the sub-diffusion layer is more unlikely to be detected by the viewer.

The sub-diffusion layer preferably has a weight lighter than the primary diffusion layer, and the weight of the sub-diffusion layer is preferably equal to or below ⅕ of the weight of the primary diffusion layer.

In this case, since the primary diffusion layer heavier than the sub-diffusion layer is arranged between the vibrating sub-diffusion layer and the viewer, the transmission of the vibration of the sub-diffusion layer and vibration sound resulting from this vibration to the viewer side is prevented by the primary diffusion layer. Thus, the viewer can view an image displayed on the image display unit without feeling any discomfort and noticing the vibration of the sub-diffusion layer.

The thickness of the sub-diffusion layer is preferably below 500 μm.

In this case, the sub-diffusion layer can be made lighter and the construction of the vibrator for applying vibration to the sub-diffusion layer can be simplified. As a result, the enlargement of the image display unit can be realized without reducing the reliability of the vibrator.

The vibrational frequency of the sub-diffusion layer is preferably below 20 Hz.

In this case, noise produced by the vibrator is reduced so as not to hinder the viewing by the viewer, and the load of the vibrator is reduced to improve the reliability of the vibrator.

It is preferable that the sub-diffusion layer includes a resin film for diffusing the laser light and a frame portion arranged around the resin film for fixing the resin film; and that the vibrator vibrates the resin film by vibrating the frame portion.

In this case, the sub-diffusion layer can be made lighter and the durability thereof can be improved. Therefore, the enlargement of the image display unit is realized without reducing the reliability of the sub-diffusion layer.

It is preferable that one surface of the sub-diffusion layer includes a Fresnel lens surface; and that the laser light is converted into substantially parallel light by the Fresnel lens surface.

In this case, the laser light can be efficiently gathered toward the viewer side without increasing the number of interfaces through which the laser light passes.

It is preferable that the sub-diffusion layer contains an electrically conductive material; and that the sub-diffusion layer is vibrated based on an electrostatic force.

In this case, unnecessary noise is not produced since the sub-diffusion layer can be vibrated without using any mechanical driving mechanism.

It is preferable that the light shielding layer contains an electrically conductive material; that the sub-diffusion layer is vibrated based on an electrostatic force; and that a gap layer having a specified thickness is arranged between the sub-diffusion layer and the light shielding layer.

In this case, the sub-diffusion layer can be vibrated using attraction forces and repulsive forces between the sub-diffusion layer and the light shielding layer while adhesion between the sub-diffusion layer and the light shielding layer is suppressed by the gap layer.

The gap layer is preferably made of a resin lens plate.

In this case, the construction of the vibrator can be simplified since adhesion between the sub-diffusion layer and the light shielding layer is prevented by the resin lens plate doubling as the gap layer.

At least one of the sub-diffusion layer containing the electrically conductive material and the light shielding layer containing the electrically conductive material detects an abnormality of the image display unit based on a change in an electrically conductive state when a voltage is applied to the electrically conductive material.

In this case, the abnormality of the image display unit can be constantly monitored during the operation of the image display device. Therefore, even in the case of breakage or the like of the image display unit, the image display device can be quickly stopped.

The electrically conductive material of the sub-diffusion layer is preferably a diffusing material for diffusing the laser light.

In this case, the sub-diffusion layer can be realized by a simple construction since a diffusing property and an electrically conductive property can be given to the sub-diffusion layer by the electrically conductive material.

The light shielding layer preferably has a patterned structure in which a plurality of transmitting portions for transmitting the laser light and a plurality of light shielding portions for absorbing outside light from the viewer side are alternately arranged.

In this case, the laser light can be transmitted toward the viewer side by the transmitting portions while the outside light from the viewer side is absorbed by the light shielding portions. Therefore, the laser light can be efficiently introduced to the viewer side while the incidence of the outside light from the viewer side on the image display unit is prevented.

The sub-diffusion layer and the light shielding layer are preferably united.

In this case, speckle noise can be more reduced by largely changing an incident light path of the laser light passing through the transmitting portions of the light shielding layer on the primary diffusion layer with time.

The light shielding layer preferably includes a selected wavelength absorbing layer for transmitting the laser light and absorbing outside light from the viewer side.

In this case, even in the case of a front projection type image display device for projecting laser light to an image display unit from a viewer side, the incidence of outside light from the viewer side on a sub-diffusion layer is prevented, so that a change of the light caused by the vibration of the sub-diffusion layer is more unlikely to be detected.

It is preferable that the image display unit further includes a two-dimensional spatial modulation element arranged between the sub-diffusion layer and the light shielding layer for modulating the laser light; and that the light shielding layer includes a polarizing layer for transmitting the laser light and absorbing outside light from the viewer side.

In this case, even in the case of a liquid crystal image display device in which laser light is incident from a light guiding plate on the rear surface of an image display unit, the incidence of outside light from a viewer side on a sub-diffusion layer is prevented, so that a change of the light caused by the vibration of the sub-diffusion layer is more unlikely to be detected.

### INDUSTRIAL APPLICABILITY

An image display device of the present invention can be utilized as the one for moving images and still images.

1-18. (canceled)

19. An image display device, comprising an image display unit for displaying an image visually recognizable by a viewer, wherein:
the image display unit includes:
a sub-diffusion layer for diffusing laser light,
a vibrator for vibrating the sub-diffusion layer,
a primary diffusion layer for diffusing the laser light diffused by the sub-diffusion layer, and
a light shielding layer for cutting off outside light from a viewer side, and
the primary diffusion layer and the light shielding layer are arranged at a viewer side of the sub-diffusion layer,
the sub-diffusion layer is shielded and protected from outside by the arrangement of the primary diffusion layer and the light shielding layer, and
the light shielding layer prevents outside light from reaching the sub-diffusion layer when the outside light from the viewer side is incident on the image display unit.

20. An image display device according to claim 19, wherein the primary diffusion layer is arranged at the viewer side of the light shielding layer.

21. An image display device according to claim 19, wherein the haze value Hm of the primary diffusion layer and the haze value Hs of the sub-diffusion layer satisfy the following relationship:
20%<Hs<Hm.

22. An image display device according to claim 19, wherein the weight of the sub-diffusion layer is equal to or below ⅕ of the weight of the primary diffusion layer.

23. An image display device according to claim 19, wherein the thickness of the sub-diffusion layer is below 500 μm.

24. An image display device according to claim 19, wherein the vibrational frequency of the sub-diffusion layer is below 20 Hz.

25. An image display device according to claim 19, wherein:
the sub-diffusion layer includes a resin film for diffusing the laser light and a frame portion arranged around the resin film for fixing the resin film; and
the vibrator vibrates the resin film by vibrating the frame portion.

26. An image display device according to claim 19, wherein:
the sub-diffusion layer includes a resin film containing an electrically conductive material, and
the vibrator vibrates the sub-diffusion layer based on an electrostatic force.

27. An image display device according to claim 26, wherein:
the light shielding layer contains an electrically conductive material;
the vibrator vibrates the sub-diffusion layer based on an electrostatic force; and
a gap layer having a specified thickness is arranged between the sub-diffusion layer and the light shielding layer.

28. An image display device according to claim 27 wherein the gap layer is made of a resin lens plate.

29. An image display device according to claim 27, wherein at least one of the sub-diffusion layer containing the electrically conductive material and the light shielding layer containing the electrically conductive material detects an abnormality of the image display unit based on a change in an electrically conductive state when a voltage is applied to the electrically conductive material.

30. An image display device according to claim 26, wherein the electrically conductive material of the sub-diffusion layer is a diffusing material for diffusing the laser light.

31. An image display device according to claim 19, wherein the light shielding layer has a patterned structure in which a plurality of transmitting portions for transmitting the laser light and a plurality of light shielding portions for absorbing outside light from the viewer side are alternately arranged.

32. An image display device according to claim 31, wherein the sub-diffusion layer and the light shielding layer are united.

33. An image display device according to claim 19, wherein the light shielding layer includes a selected wavelength absorbing layer for transmitting the laser light and absorbing outside light from the viewer side.

34. An image display device according to claim 19, wherein:
the image display unit further includes a two-dimensional spatial modulation element arranged between the sub-diffusion layer and the light shielding layer for modulating the laser light; and
the light shielding layer includes a polarizing layer for transmitting the laser light and absorbing outside light from the viewer side.
